(19) United States
(12) Patent Application Publication
(10) Pub. No.: US 2005/0195336 A1
(43) Pub. Date: Sep. 8, 2005

(54) Integrated television receivers with I and Q analog to digital converters

(76) Inventors: Matthew Glenn Waight, Pipersville, PA (US); Brian Dacey, Howell, NJ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/794,617

(22) Filed: Mar. 5, 2004

(51) Int. Cl. H04N 5/455

(52) U.S. Cl. 348/725

(57) ABSTRACT

Integrated television receivers with I and Q analog to digital converters on the integrated circuit. The television receivers may be nearly fully integrated, typically with one or more filter elements such as one or more inductors off chip. Single conversion and double conversion versions of the invention are disclosed. In single conversion versions, conversion to baseband is disclosed. In double conversion versions, conversion first upward to a high IF frequency, and then conversion to baseband is disclosed. Various other features are disclosed.

### BACKGROUND OF THE INVENTION

1. Field of the Invention

The present invention relates to the field of analog and digital television receivers and broadband data receivers.

2. Prior Art

The present state of art in television receivers is a single-conversion or dual-conversion architecture with a balanced IF output, requiring at least one IF (intermediate frequency) SAW (surface acoustic wave) filter and subsequent gain stage to drive an analog demodulator or external Analog-to-Digital Converter (ADC), which is typically in a demodulator integrated circuit.

### BRIEF DESCRIPTION OF THE DRAWINGS

FIG. 1 is a block diagram of a television receiver in accordance with one embodiment of the present invention.

FIGS. 2a through 2c illustrate a High-IF filter using integrated and/or external inductors and switched-capacitor array filters, a circuit illustrating the capacitor switching and a graph illustrating a typical frequency response for the filter, respectively.

FIG. 3 is a block diagram of a television receiver similar to that of FIG. 1, though having analog-to-digital converters that are a pipeline type with a parallel output.

FIGS. 4 and 5 illustrate single conversion embodiments of the present invention.

FIG. 6 illustrates further signal processing that may be done in the demodulator.

### DETAILED DESCRIPTION OF THE PREFERRED EMBODIMENTS

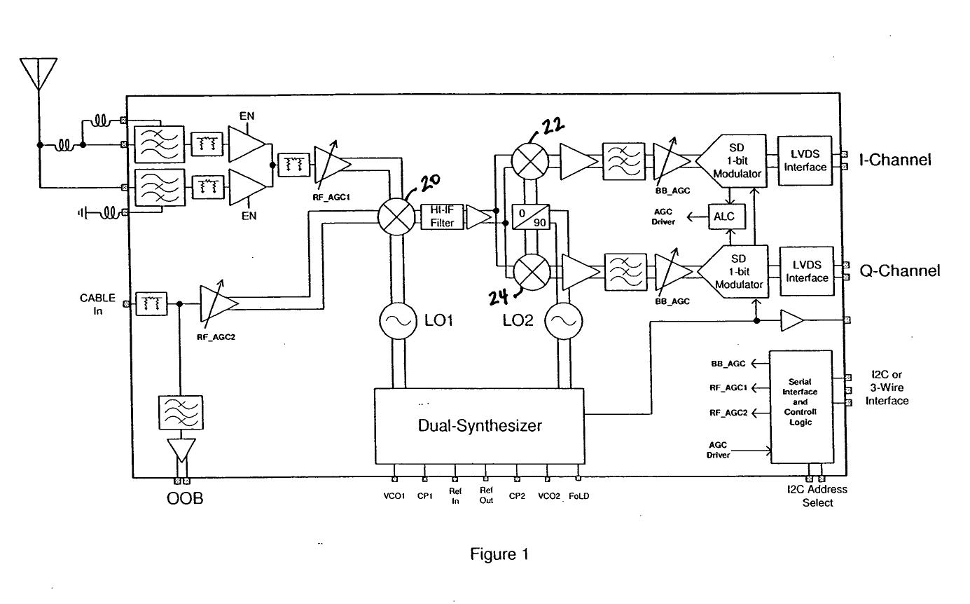

Now referring to FIG. 1, a block diagram of a receiver having two receiver inputs, a cable input and an antenna input having both a VHF input pin and a UHF input pin, may be seen. One of the three inputs are band pass filtered, amplified and sent to the Up-Converter mixer 20. The mixer 20, as well as the I and Q down shifting mixers 22 and 24, use frequency references from local oscillators LO1 and L02 controlled by the externally controlled Dual Synthesizer. Local oscillator L02 generally operates at a constant frequency to down shift the output of the HI-IF filter to baseband, while local oscillator LO1 varies, depending on the channel selection, causing mixer 20 to up-shift the desired channel to the band pass frequency of the HI-IF filter.

From the mixer 20, the converted signals are filtered by the High-IF filter. This filter can be a simple bandpass filter, using integrated and/or external inductors and switched-capacitor array filters.

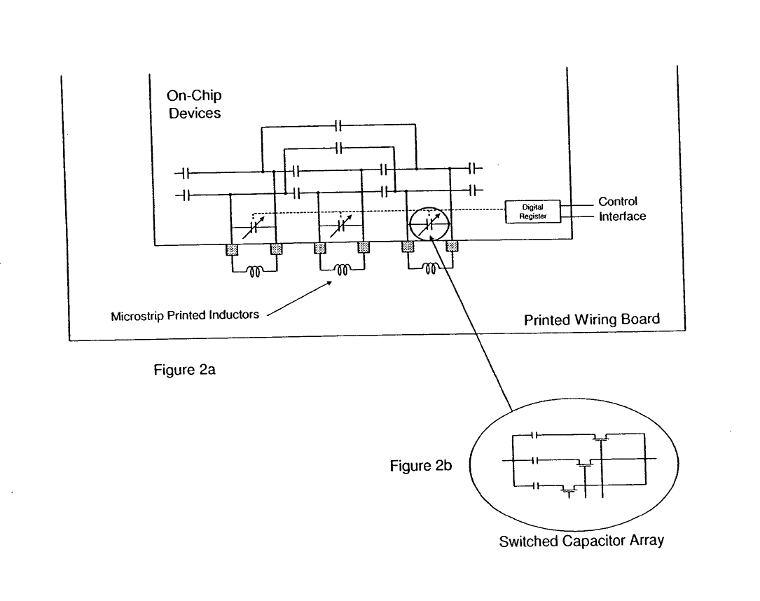

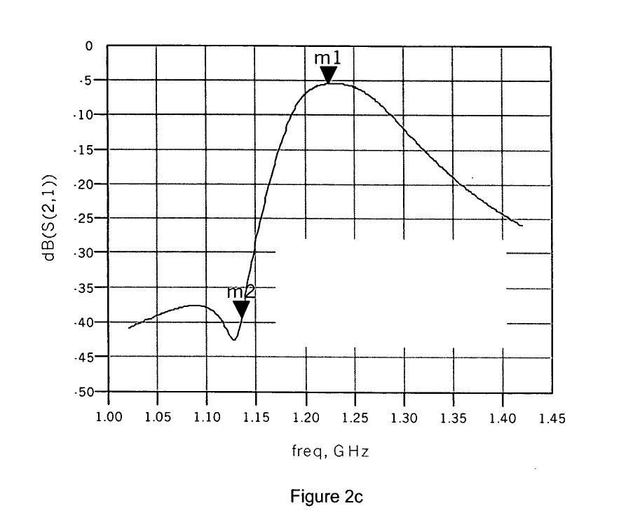

An example of a High-IF filter using integrated and/or external inductors and on-chip switched-capacitor array filters may be seen in FIG. 2a. The inductors for the filter may be microstrip printed inductors on a printed wiring board to which the integrated circuit is mounted. Tuning for the filter may be by way of capacitor switching, three capacitor switching being illustrated in FIG. 2b, though more may be provided if desired. The switches may be controlled, typically through the serial interface at the time an entire TV receiver is assembled, to tune the circuit for the desired frequency response, given reasonable fabrication tolerances on the switched capacitors themselves and the external inductors. A typical filter response is illustrated in FIG. 2c, where the desired frequencies (M1) are passed with little attenuation and the image frequencies (M2) are highly attenuated.

The output of the HI-IF filter is amplified and then down converted to baseband by I and Q mixers 22 and 24. Following the mixers is an amplifier for each of the I and Q channels and a low-order low-pass filter to further attenuate adjacent channels and serve as an anti-alias filter. Next is a VGA (variable gain amplifier) in each channel which drives an analog to digital converter for that channel, either a single bit or multiple bit Sigma-Delta data ADC or modulator, or a track-and-hold pipeline ADC. The output of the ADC is a bit-stream. For a Sigma-Delta ADC, the bit-stream is converted to a balanced, low-voltage differential signal by the LVDS circuit, which communicates to an off chip digital demodulator.

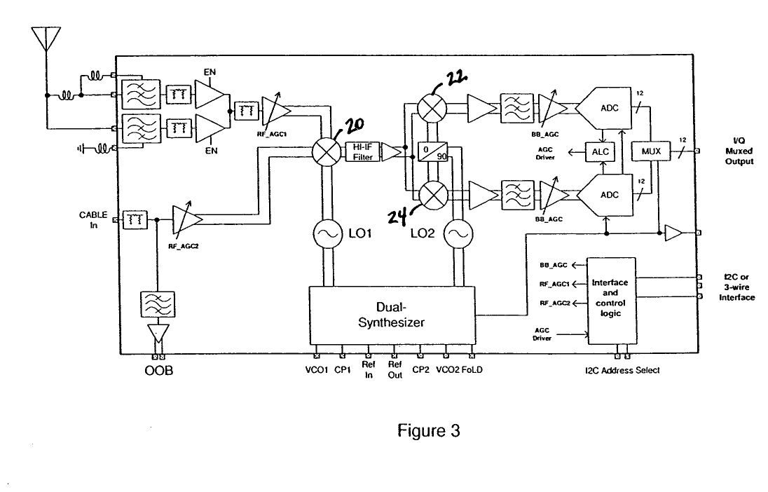

The circuit shown in FIG. 3 is similar to that of FIG. 1, but the analog-to-digital converters are pipeline type with a parallel output. The pipeline ADCs, having a much lower data-rate, can have the two bit-streams multiplexed together as shown for transfer of the data to the demodulator. This reduces the number of I/O pins for the receiver and the demodulator integrated circuits.

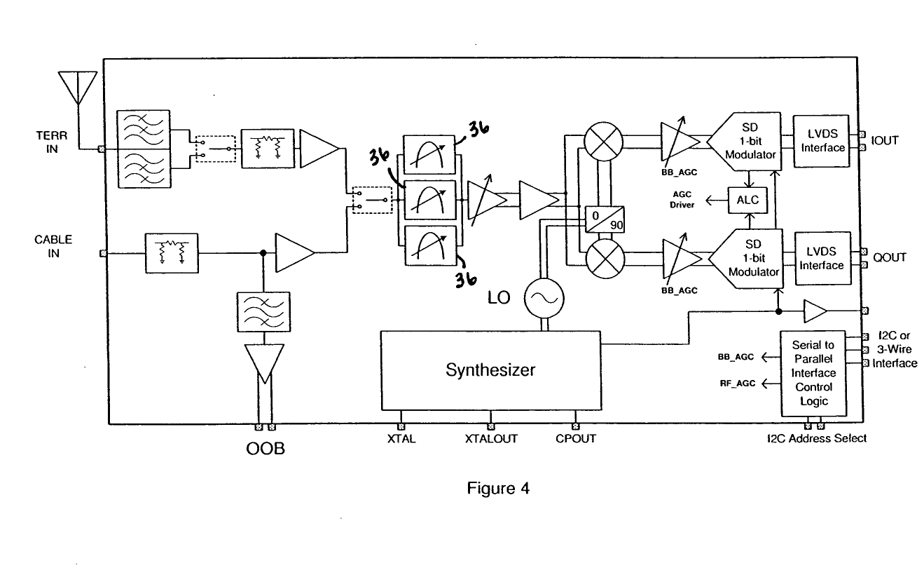

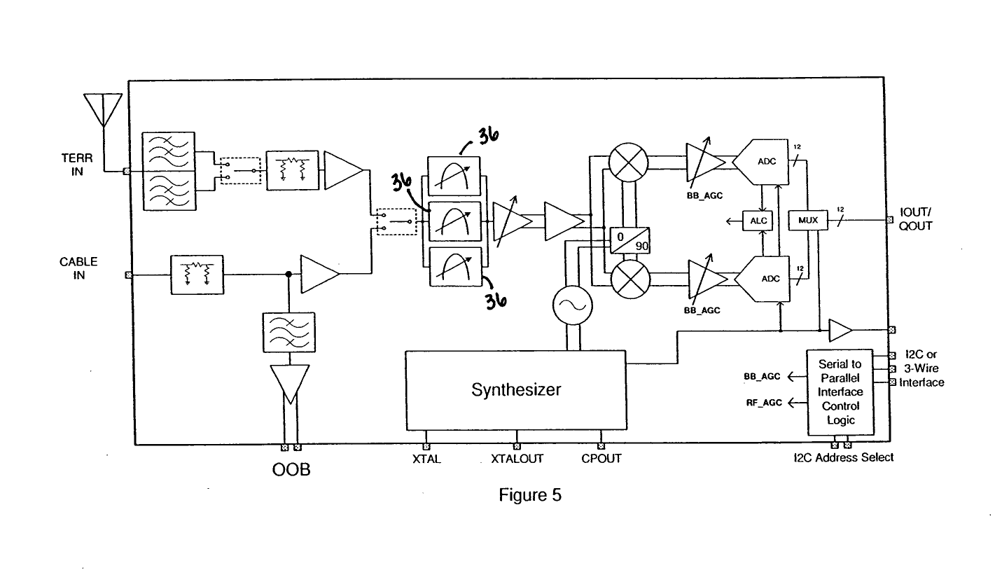

Alternatively, a single (direct) conversion approach can be used (see FIGS. 4 and 5) with the incorporation of integrated tracking filters consisting of monolithic high-Q inductors and switched capacitor arrays. Several tracking filters 36 are used in a sub-banding configuration to cover the entire VHF and UHF TV bands. Each filter is tunable over a limited frequency range, with the one filter for any one desired frequency being switched into the circuit and tuned as required. The circuits shown in FIGS. 4 and 5 show such direct conversion receivers incorporating both pipe-line and sigma-delta ADC structures, respectively.

Thus the present invention introduces a zero IF, eliminating the need for an IF SAW filter, and also incorporates I and Q channel ADCs on the receiver integrated circuit. The result is an RF-to-Bits solution, eliminating the need for ADCs within the demodulator ICs, simplifying the continuous transition to ever smaller CMOS device geometries and lower supply voltages. IF SAW filters and IF VGA stages are also eliminated, further simplifying the board-level design.

Additionally, a High-IF filter is also integrated, using inductors, capacitors, and switched-capacitor arrays to form a filter on-die, or by using a fcLGA (flip chip land grid array) where external printed inductors are used along with on-die switched capacitor arrays that together form a high-IF filter.

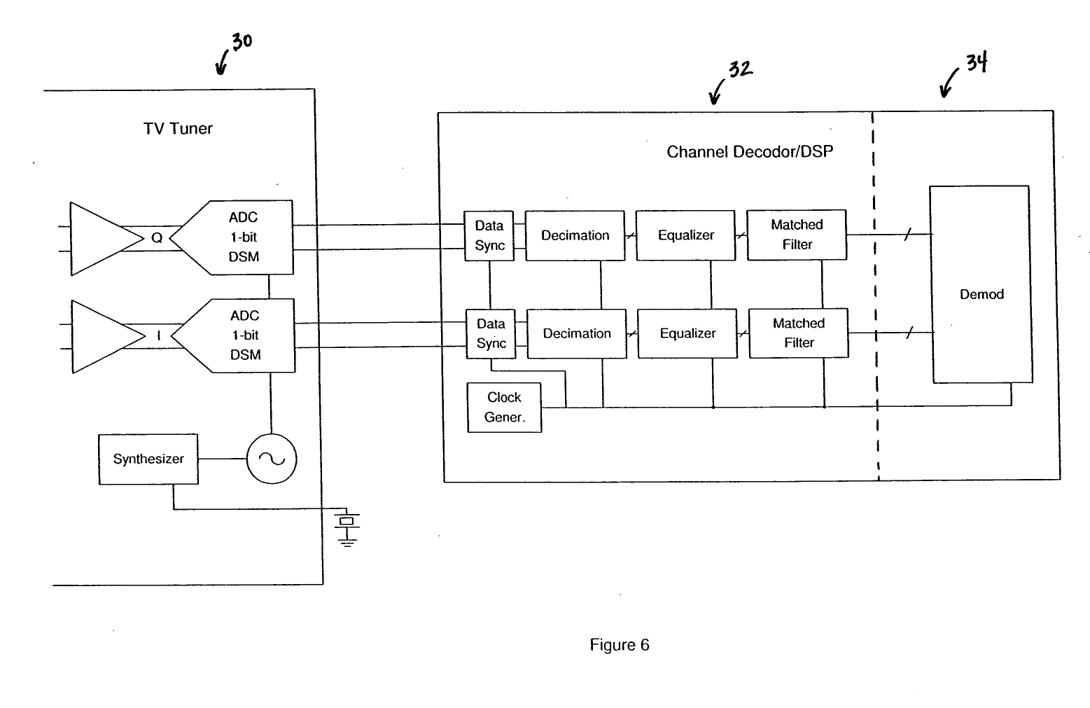

The present invention may be extended whereby additional signal processing occurs within the digital demodulator, which may simply be a DSP (digital signal processor). This additional signal processing would be defined by the particular implementation of the RF receiver and Analog to Digital Converters. This may include, but is not limited to, clock recovery, decimation of the receiver output bit stream(s), adaptive equalization of the output bit streams(s) and additional interference filtering in the digital domain. By way of example, FIG. 6 schematically illustrates a receiver integrated circuit 30, the additional signal processing in block 32, and demodulation. Since the signals are received and all of the functions in blocks 32 and 34 are in the digital domain, the functions of both blocks 32 and 34 may be carried out in a digital signal processor without requiring an analog to digital interface on the DSP chip or as a separate chip between the receiver chip and the DSP. Thus the receiver can be used as a multimode receiver for analog and/or digital television and/or for data.

While certain preferred embodiments of the present invention have been disclosed and described herein, it will be understood by those skilled in the art that various changes in form and detail may be made therein without departing from the spirit and scope of the invention. Similarly, the various aspects of the present invention may be advantageously practiced by incorporating all features or various sub-combinations of features.

1. A television receiver comprising:
an integrated circuit having an up converter for converting a received RF television signal to a high intermediate frequency signal, down converters for converting the high intermediate frequency signal to baseband I and Q signals, and an analog to digital converter coupled to each of the I and Q signals to convert to digital signals for output from the integrated circuit.

2. The receiver of claim 1 wherein each analog to digital converter is a sigma-delta modulator.

3. The receiver of claim 1 wherein each analog to digital converter is a single bit sigma-delta modulator.

4. The receiver of claim 1 wherein each analog to digital converter is a multiple bit sigma-delta modulator.

5. The receiver of claim 1 wherein each analog to digital converter is a track-and-hold pipeline analog to digital converter.

6. The receiver of claim 5 further comprised of a multiplexer coupled to multiplex the outputs of the track-and-hold pipeline analog to digital converters for output from the integrated circuit.

7. The receiver of claim 1 further comprised of low pass filters to suppress adjacent channel frequencies in the baseband signals.

8. A television receiver comprising:
an integrated circuit having down converters for converting a received RF television signal to baseband I and Q signals, and an analog to digital converter coupled to each of the I and Q signals to convert to digital signals for output from the integrated circuit.

9. The receiver of claim 8 wherein the analog to digital converter is a sigma-delta modulator.

10. The receiver of claim 8 wherein the analog to digital converter is a single bit sigma-delta modulator.

11. The receiver of claim 8 wherein the analog to digital converter is a multiple bit sigma-delta modulator.

12. The receiver of claim 8 wherein the analog to digital converter is a track-and-hold pipeline analog to digital converter.

13. The receiver of claim 12 further comprised of a multiplexer coupled to multiplex the outputs of the track-and-hold pipeline analog to digital converters for output from the integrated circuit.

14. A television receiver comprising:
an integrated circuit having an up converter for converting a received RF television signal to a high intermediate frequency signal, down converters for converting the high intermediate frequency signal to baseband I and Q signals, and first and second local oscillators coupled to the up converter and the down converters, respectively.

15. The receiver of claim 14 further comprised of a switched capacitor filter between the up converter and the down converter, the switched capacitor filter having at least one inductor coupled to the switched capacitor filter.

16. The receiver of claim 15 wherein the integrated circuit, including a switched capacitor array for the switched capacitor filter, is on one die and the and at least one inductor printed externally to the die, the die and inductor both being packaged on a land grid array printed wire board.

17. A television receiver comprising:
an integrated circuit having an up converter to convert a received RF television signal to a high intermediate frequency signal, switched capacitor arrays on the integrated circuit for use as part of a band pass filter to pass a desired channel and to suppress other channels in the high intermediate frequency signal, down converters converting the filtered high intermediate frequency signal to baseband I and Q signals, and analog to digital converters coupled to convert the I and Q signals to digital signals for output from the integrated circuit; and,
one or more printed inductors on a printed wiring board to which the integrated circuit is mounted and operative with the switched capacitor arrays to form the band pass filter.

18. The receiver of claim 17 wherein the switched capacitor arrays are controllable through an interface on the integrated circuit to tune the band pass filter.

19. A receiver comprising:
an integrated circuit coupled to and functioning with one or more filter elements that are not part of the integrated circuit, the integrated circuit being coupled to receive an RF television signal, the integrated circuit being responsive to control inputs to select a channel, to down shift the channel into I and Q components and to convert the I and Q components to I and Q digital output signals;
a digital signal processor coupled to receive the I and Q digital output signals and programmed to perform one or more of the operations of decimation of the receiver output bit streams, adaptive equalization of the output bit streams and additional interference filtering in the digital domain, and to then demodulate the I and Q digital signals.

20. The receiver of claim 19 wherein the one or more filter elements that are not part of the integrated circuit comprise an inductor.

21. The receiver of claim 19 wherein the selected channel is down shifted to I and Q components at baseband frequency.

22. The receiver of claim 19 wherein the I and Q components are converted to I and Q digital output signals by single bit analog to digital converters on the integrated circuit.
